(19) United States
(12) Patent Application Publication
(10) Pub. No.: US 2016/0188393 A1
(43) Pub. Date: Jun. 30, 2016

(54) AUTOMATIC PHASE DETECTION

(71) Applicants: Reza Zamani, San Jose, CA (US); Jonathan M. Eastep, Portland, OR (US)

(72) Inventors: Reza Zamani, San Jose, CA (US); Jonathan M. Eastep, Portland, OR (US)

(21) Appl. No.: 14/583,289

(22) Filed: Dec. 26, 2014

(51) Int. Cl. G06F 11/07; G06N 5/04

(52) U.S. Cl. CPC G06F 11/079; G06F 11/0721; G06N 5/04

(57) ABSTRACT

Systems, apparatus, and methods may provide for a significant change identifier to output a value indicating a prediction error function from input system characteristics. A filter may be used to analyze the value indicating the prediction error function to identify a potential phase marker to indicate at least a beginning or end of a process phase. An extractor may obtain phase properties for a phase delineated by at least a beginning phase marker, and a predictor may determine an upcoming phase or estimate an ongoing phase from the obtained phase properties.

### TECHNICAL FIELD

Embodiments generally relate to automatic phase detection. More particularly, embodiments relate to automatic phase detection to characterize workload phases.

### BACKGROUND

Application or system behavior may be broken down into segments that exhibit stable behavior; each stable segment may be referred to as a phase. Manual phase detection may be time consuming, costly and/or impractical in real-time applications.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a system including an apparatus to characterize workload phases according to an embodiment;

FIG. 2 is a flowchart of an example of a method of operating an apparatus to characterize workload phases according to an embodiment;

FIG. 3 is a flowchart of an example of a method of operating a system including an apparatus to characterize workload phases according to an embodiment;

FIG. 4 is a flowchart of an example of a portion of the method of FIG. 3 according to an embodiment;

FIG. 5 is a plot of an example of automatic phase identification for plural input signals according to an embodiment; and

FIG. 6 is a plot of an example of spatial binning according to an embodiment.

### DESCRIPTION OF EMBODIMENTS

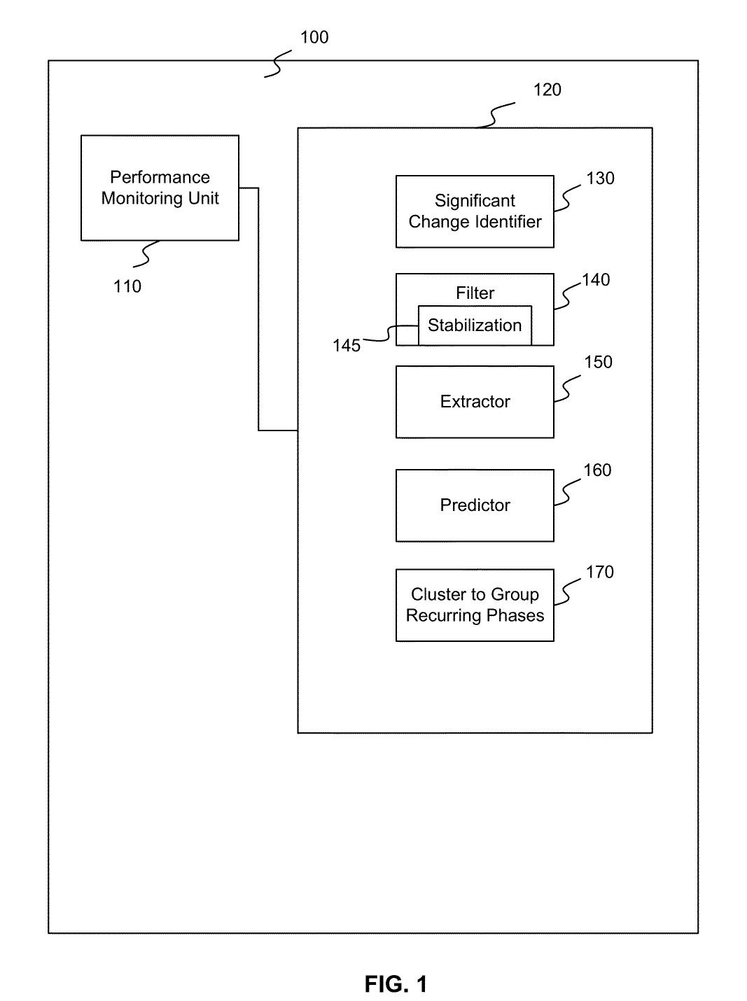

Turning now to FIG. 1, system 100 including a performance monitoring unit 110 and an apparatus 120 to characterize workload phases is schematically depicted. The apparatus 120 to characterize workload phases includes a significant change identifier 130 that may receive a variety of input signals and output a prediction error function or any other value that indicates a level of change. A prediction error function may be a function that at least uses a pair of observed and predicted values. For example, in a case of using a difference function, the prediction error function outputs the difference between an observed and a predicted value which is commonly known as prediction error. As depicted in FIG. 1, one source of input signals may be a performance monitoring unit 110; other sources, however, are also contemplated including any signal source that indicates system characteristics and statistics. Another example of an input signal may be a signal from a power monitoring unit.

A filter 140 may analyze the prediction error function or any other value that indicates a level of change to identify a potential phase marker to indicate a beginning or end of a process phase. One technique for analysis is to compare prediction errors or other values to a threshold determined in the runtime. The filter 140 may include a stabilization state machine 145 that may determine whether a phase has started. An extractor 150 may obtain phase properties for a phase delineated by at least a beginning phase marker. A predictor 160 may determine an upcoming phase or estimate an ongoing phase from the obtained phase properties. Optional cluster logic 170 may perform clustering to group recurring phases.

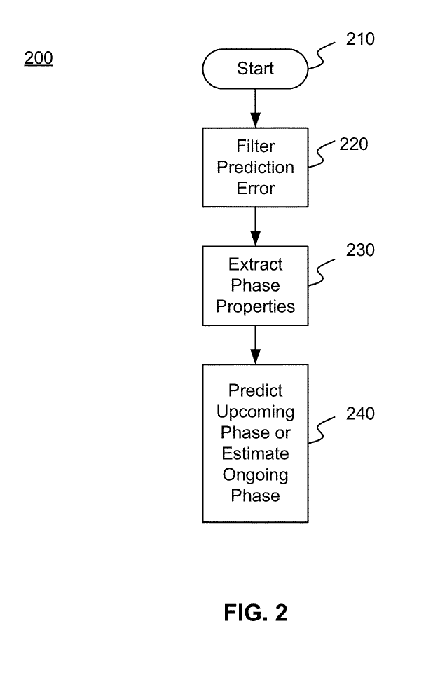

In use, the system of FIG. 1 may perform a method 200 depicted in FIG. 2. The method 200 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. At illustrated start block 210, there may be input one or more signals indicating system characteristics to a significant change identifier to output a prediction error function or other value indicating a level of change. At illustrated block 220, there may be filtering of the prediction error function/change value to identify a potential phase marker to indicate a beginning or an end of a process phase. At block 230 there may be extraction of phase properties for a phase delineated by at least a beginning phase marker. In illustrated block 240 there may be prediction of an upcoming phase or estimation of an ongoing phase from the extracted phase properties.

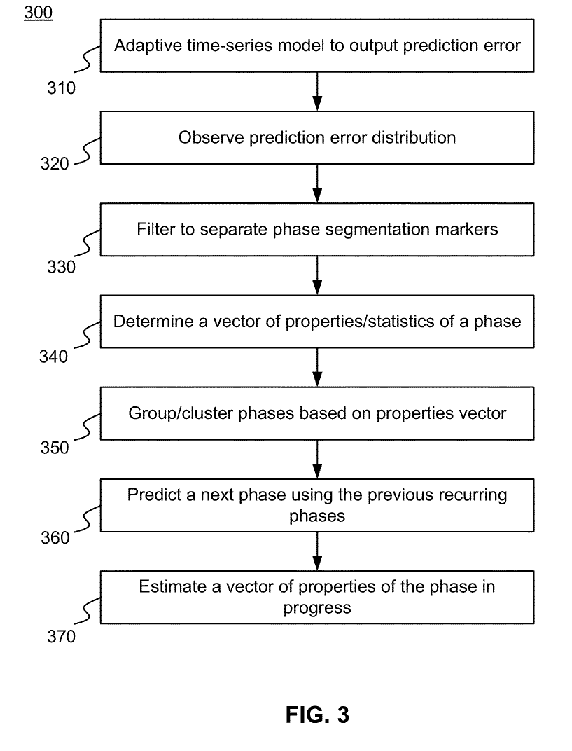

A more detailed method 300 for the system FIG. 1 is outlined in the flowchart of FIG. 3. With continuing reference to both FIGS. 1 and 3, at illustrated block 310, metrics such as performance monitoring counters (or functions of these metrics, such as their ratios) or power consumption metrics, but not limited to these, are fed into the significant change identifier 120. The significant change identifier 120 in the exemplary embodiment of block 310 is an adaptive time-series model to learn regression coefficients and predict values for the metrics in the block. An example of an adaptive time-series model is an ARIMAX (Autoregressive Integrated Moving Average with Exogenous Inputs) model which is a multivariate model predicting one of input signals and an RLS (Recursive Least Squares) Model that updates the coefficients of the ARIMAX model. One representation of the ARIMAX (m, r, n, d) model that may be used is shown in equations (1) and (2):

$$\begin{matrix}{y}_{t} = {ɛ}_{t} + {\sum }_{i = 1}^{m} {α}_{i} {y}_{t - i} + {\sum }_{j = 1}^{p} {\sum }_{i = 0}^{q - 1} {β}_{j , i} {x}_{j , i - i} + {\sum }_{i = 1}^{r} {η}_{i} {ɛ}_{t - i} & ( 1 ) \\ {y}_{t} = {( 1 - L )}^{d} {Y}_{t} , {x}_{t} = {( 1 - L )}^{d} {X}_{t} , {LX}_{t} = {X}_{t - 1} , n = pq & ( 2 )\end{matrix}$$

The m is the number of autoregressive terms. The n (n=pq) is the total number of exogenous input terms and p represents the number of exogenous input signals with q terms each. The r is the number of moving average terms. The L is a lag operator defined in (2). The d is the number of initial differencing on the input signals that represents the integrated part of ARIMAX model. For example, if d=1 then xₜ=Xₜ−Xₜ₋₁. The coefficients in (1) (α,β,η) are determined in runtime through an algorithm, such as recursive least squares or a Kalman filter. One of the metrics that is being modeled is Yₜ and this is done by first modeling the initially d-times differenced values of Yₜ (i.e., yₜ) with respect to its previous values (e.g., yₜ₋ᵢ) and p other metrics (also initially d-times differenced i.e., x_{j,t}) at the current time and previous q−1 samples (i.e., x_{j,t-i}) and the error of this time series in the last r time samples (i.e., εₜ₋ᵢ). The error of this adaptive time series (i.e., εₜ) is the prediction error that may be output from illustrated block 310.

The prediction error may be fed to a modeling error distribution observer in block 320. Based on the distribution of this error the spikes/significant values are detected over time using an obtained threshold from the distribution, such as standard error of εₜ over time. Once the significant spikes in the error are identified they may be used as candidates for behavior change markers to refer to a start and an end of a phase. Not all of the candidates, however, are marking a start or an end of a phase as during a transition period. The period, and their associated samples, between a stop marker and the following start marker is referred to as a transition period. In a transition period, stable behavior is not established and a series of markers will be generated. It is noted that not all of the original samples will be a part of a phase or will be generating a significant change marker. For example, a sample that is not a significant change marker might appear immediately between two samples that are significant change markers. Therefore, such samples, a small portion of the total samples, are discarded in the stabilization period in the sense that they will not be a part of any stable phase and their statistics will not be extracted.

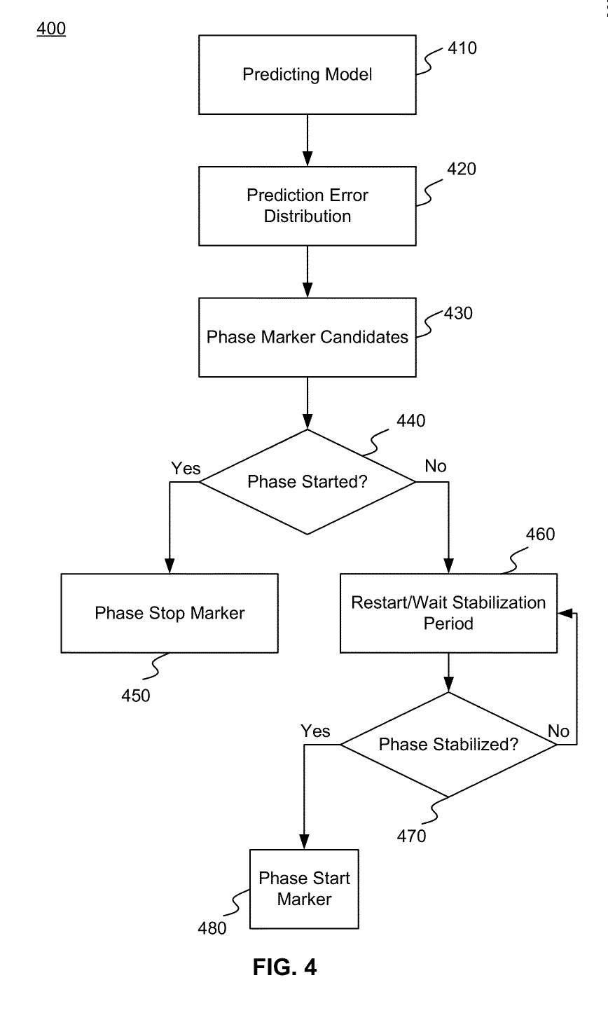

A more detailed explanation of blocks 310-330 is depicted in the flowchart of FIG. 4. In FIG. 4, the predicting model (such as the ARIMAX model described above) receives input parameters and outputs a prediction error function distribution at block 420. From the output error distribution, outlier points are identified as phase marker candidates at block 430. At block 440, these outlier points are used to determine if they should become phase start or end markers. If a phase has already started, an input outlier point may indicate a phase stop marker at block 450. If a phase has not already started a restart/wait stabilization period begins at illustrated block 460. If the phase has stabilized in block 470, then a phase start marker will be established at illustrated block 480. If a phase has not stabilized, it may be a transition period and the process returns to block 460 until the waiting period is over and the phase is stabilized.

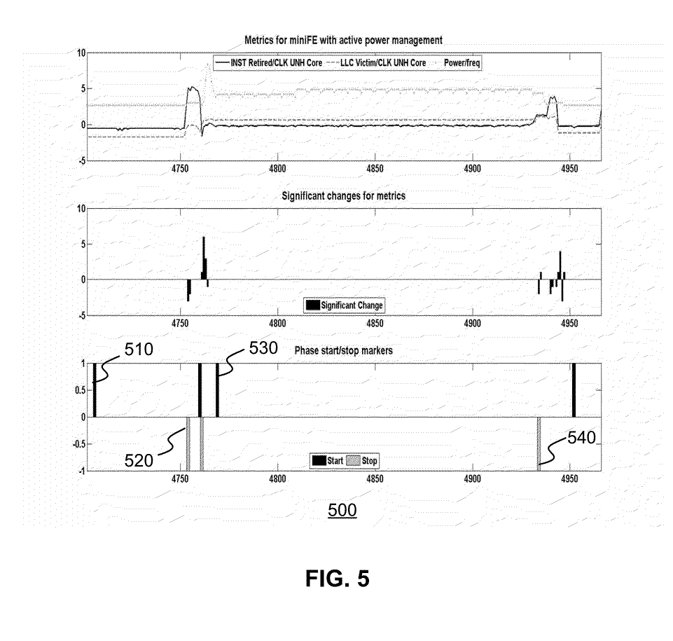

An illustration of stop and start markers is depicted in FIG. 5. Normalized performance or power input signals are depicted in the top graph, significant changes for metrics in the center graph, and corresponding phase start and stop markers in the bottom graph. Elements 510 and 530 are start markers while elements 520 and 540 are the respective stop markers. The various significant change markers that do not correspond to stop and start markers occur in transition periods where a phase has not yet stabilized.

Returning to the explanation of FIG. 3, the significant spikes in error, or prediction error function values, or other value indicting significant change (candidates for behavior change markers) are output to a filter (element 140 in FIG. 1) that rejects anything but statistically significant spikes in the error at illustrated block 330. Filtering may be performed in various ways. One method is a waiting period for a limited time to observe at least a minimum number of samples without any significant transition makers to establish a stable phase. Statistically significant spikes are candidates for phase changes. These candidates are sent to a stabilization state machine (element 145 in FIG. 1) which restarts if there are new spikes and counts up if there are not; if a spike is the only spike for several consecutive time steps (e.g., four consecutive time steps), it is accepted as a start maker phase change, and the system outputs that a new phase has started. Once the phase is established (a phase start marker) then this phase is maintained until a next transition marker is detected. Any significant spike in the error during an established phase is regarded as a stop marker phase change and the system outputs that a phase has stopped. Optionally included as part of a phase are those samples that have no significant change candidates while waiting for a phase marker. For example, if a significant change signal is observed and then during the stabilization period (e.g., waiting for four samples) there is no significant change, the four samples would be included as part of the phase. This means that the phase start markers described here are determined to be phase start markers when the phase is determined to be a phase, however, the last n (here, n=4) samples in the waiting period were also a part of the phase as there were no significant changes since the last significant change. Virtually the phase start marker would then be n=4 samples earlier, but that information is not available until the n=4 samples have passed and the phase is established.

This successful waiting time is an overhead in the phase detection. In one embodiment this overhead is mitigated by using the prediction of upcoming phases that is outputted by block 160 of FIG. 1. For example, when it is expected that a phase has most likely started and while waiting for the stabilization period to fully determine an established phase, this prediction provides a good estimate of the start of a new phase and/or its properties.

The start and stop markers identified by the filtering of block 330 are then fed to illustrated block 340 which processes the segments between markers at a higher level of abstraction and extracts properties (e.g., statistics) of a marked segment using extractor 150 of FIG. 1 and outputs this information in a vector format. Examples of such statistics are mean and standard error of X and Y and length of the phase. Furthermore, this set of properties for each phase is compiled into a vector format where each element represents one of the calculated statistics.

This vector of properties for each phase/segment is outputted to illustrated block 350 where vectors are clustered into groups using cluster logic 170 of FIG. 1. Each obtained group is used to uniquely label the phases/segments associated with it. At this stage each phase of the application can be analyzed at a higher abstraction layer by looking at its label. Clustering techniques, such as spatial binning or Mahalanobis clustering, may be used to group the recurring phases. After grouping the phases together, they are labeled based on their group number and can be now analyzed at a higher abstraction layer. An example of grouping a vector of properties such as <length, Y̅, Y_{σ}, . . . >, where Y̅ and Y_{σ} represent mean and standard error of Y, is to divide the span range of each dimension of this vector into k equal bins and if the value of that dimension falls within the i^{th} bin then i is assigned as the label.

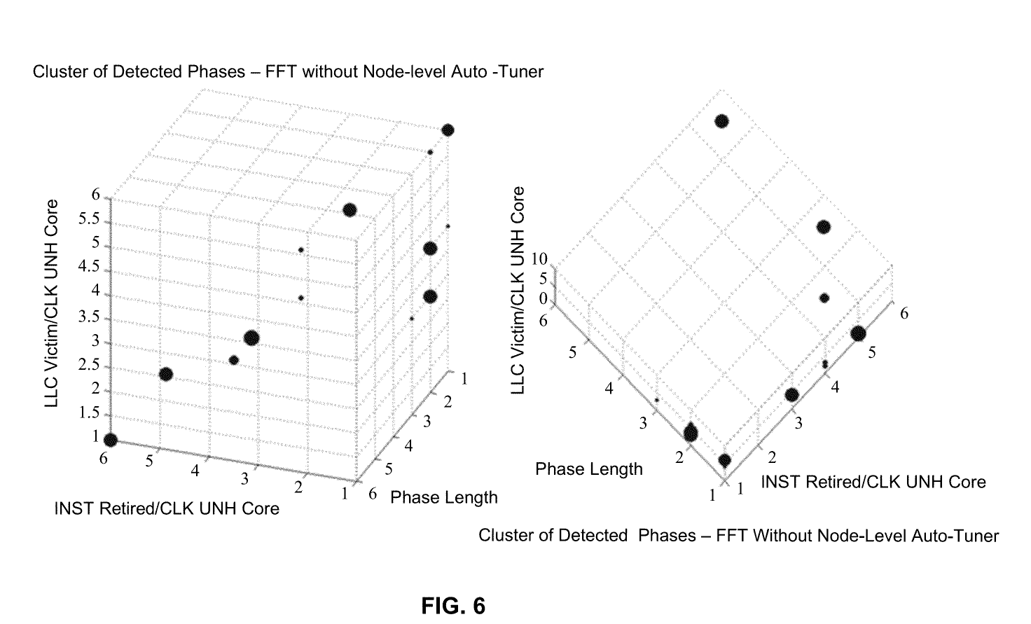

As an example, a visual representation of some of the clustering results of block 350 is shown in FIG. 6. In FIG. 6 the clusters are represented by circular points on a three-dimensional grid. The abstract values can now be treated at a higher level of abstraction for prediction of future phases and estimation of the current phase in progress. The size of a circle represents the number of times a phase recurs.

The obtained labels from application phases and their occurrence patterns are then fed into the predictor (element 160 of FIG. 1) to predict the next phase based on the previous label patterns in illustrated block 360 of FIG. 3. For example, a history table can be used to count the pairs of phase property vectors that appear during the runtime and based on the obtained frequency, predict the next phase based on the current phase and the history table. Various models can be applied to the abstracted property vector of the obtained phases.

Alternatively, once a new phase is established, the partial statistics obtained before the phase stop marker has been reached, as well as looking up the partial statistics in the clustered group of property vectors may be used to estimate the full property vector of current phase in illustrated block 370 of FIG. 3. Once a phase is established it remains ongoing until it is ended by the next transition marker (i.e., significant modeling error). The partially obtained property vector of the current phase (except phase length), when a phase is ongoing, may be used combined with the previously obtained property vectors to estimate the final values of the current property vector before it is finished. For example, a partial property vector of a phase that has been labeled as A in Block 350 previously suggests that the length of the current phase may be similar to the phases that A has recorded. The estimation of current phase may be updated for each added sample in time. A data fusion between the results of blocks 350 and 360 and the partial ongoing property vector may also be another method for estimating the current phase and its final statistics. This is valuable information for an optimization layer to maximize its efficiency.

### Additional Notes and Examples

Example 1 may include a system including a performance monitor to output performance monitoring signals, a significant change identifier to receive input performance monitoring signals and output a prediction error function, a filter to analyze the prediction error function to identify a potential phase marker to indicate a beginning or end of a process phase, an extractor to obtain phase properties for a phase delineated by at least a beginning phase marker, and a predictor to determine an upcoming phase or estimate an ongoing phase from the obtained phase properties.

Example 2 may include the system of example 1, wherein the significant change identifier includes logic having a multivariate model predicting a signal from the input performance monitoring signals.

Example 3 may include the system of examples 1 or 2, wherein the filter includes logic to analyze a prediction error function on the basis of outlier errors.

Example 4 may include the system of examples 1 or 2, wherein the extractor includes logic to calculate a vector of properties of the phase.

Example 5 may include the system of examples 1 or 2, wherein a complete phase is to be delineated by a beginning marker and an end marker.

Example 6 may include the system of examples 1 or 2, further comprising logic to perform clustering to group recurring phases.

Example 7 may include an apparatus to characterize workload phases including a significant change identifier to output a prediction error function from input system characteristics a filter to analyze the prediction error function to identify a potential phase marker to indicate a beginning or end of a process phase, an extractor to obtain phase properties for a phase delineated by at least a beginning phase marker, and a predictor to determine an upcoming phase or estimate an ongoing phase from the obtained phase properties.

Example 8 may include the apparatus of example 7, wherein the significant change identifier includes logic having a multivariate model predicting a signal from input system characteristics.

Example 9 may include the apparatus of examples 7 or 8, wherein the filter includes logic to analyze the prediction error function on the basis of outlier errors.

Example 10 may include the apparatus of examples 7 or 8, wherein the extractor includes logic to calculate a vector of properties of the phase.

Example 11 may include the apparatus of examples 7 or 8, wherein a complete phase is to be delineated by a beginning marker and an end marker.

Example 12 may include the apparatus of examples 7 or 8, further comprising logic to perform clustering to group recurring phases.

Example 13 may include a method to characterize workload phases of a process including inputting one or more signals indicating system characteristics to a significant change identifier to output a prediction error function, filtering the prediction error function to identify a potential phase marker to indicate a beginning or an end of a process phase, extracting phase properties for a phase delineated by at least a beginning phase marker, and predicting an upcoming phase or estimating an ongoing phase from the extracted phase properties.

Example 14 may include the method of example 13, further including clustering to group recurring phases.

Example 15 may include the method of examples 13 or 14, further including generating a phase vector from the extracted phase properties.

Example 16 may include the method of example 15, wherein predicting a future phase further includes generating a history of phase property vectors and predicting a future phase based on a current phase and the generated history.

Example 17 may include the method of examples 13 or 14, wherein the filtering identifies a potential phase marker based on the prediction error function being an outlier error.

Example 18 may include the method of examples 13 or 14, wherein the significant change identifier includes logic having a multivariate model predicting a signal from input system characteristics.

Example 19 may include at least one computer readable storage medium including a set of instructions which, when executed by a computing device, cause the computing device to input one or more signals indicating system characteristics to a significant change identifier to output a prediction error function, filter the prediction error function to identify a potential phase marker to indicate a beginning or an end of a process phase, extract phase properties for a phase delineated by at least a beginning phase marker, and predict an upcoming phase or estimate an ongoing phase from the extracted phase properties.

Example 20 may include the at least one computer readable storage medium of example 19, wherein the instructions, when executed, cause the computing device to perform clustering to group recurring phases.

Example 21 may include the at least one computer readable storage medium of examples 19 or 20, wherein the instructions, when executed, cause the computing device to generate a phase vector from the extracted phase properties.

Example 22 may include the at least one computer readable storage medium of example 21, wherein predicting a future phase further includes instructions, when executed, that generate a history of phase property vectors and predict a future phase based on a current phase and the generated history.

Example 23 may include the at least one computer readable storage medium of examples 19 or 20, wherein the instructions to filter the prediction error function further include identifying a potential phase marker based on the prediction error function being an outlier error.

Example 24 may include the at least one computer readable storage medium of examples 19 or 20, wherein the significant change identifier includes logic having a multivariate model predicting a signal from input system characteristics.

Example 25 may include an apparatus to characterize workload phases including means for inputting one or more signals indicating system characteristics to a significant change identifier to output a prediction error function, means for filtering the prediction error function to identify a potential phase marker to indicate a beginning or an end of a process phase, means for extracting phase properties for a phase delineated by at least a beginning phase marker, and means for predicting an upcoming phase or estimating an ongoing phase from the extracted phase properties.

Example 26 may include the apparatus of example 25, further including means for clustering to group recurring phases.

Example 27 may include the apparatus of examples 25 or 26, further including means for generating a phase vector from the extracted phase properties.

Example 28 may include the apparatus of example 27, wherein predicting a future phase further includes means for generating a history of phase property vectors and means for predicting a future phase based on a current phase and the generated history.

Example 29 may include the apparatus of examples 25 or 26, wherein the filtering identifies a potential phase marker based on the prediction error function being an outlier error.

Example 30 may include the apparatus of examples 25 or 26, wherein the significant change identifier includes logic having a multivariate model predicting a signal from input system characteristics.

Thus, embodiments described above facilitate automatic inference and characterization of workload phases. This capability can be used in power management systems and processor tracing systems to enable better results. For example, a power management system can use phase characterizations to comprehend and predict how application behavior varies in time and make decisions optimized for better application performance or efficiency. In another example, a processor tracing system can use identification of recurring phase behavior to abbreviate traces into summaries for each phase and significantly reduce the data bandwidth needed for transferring information. Embodiments improve power and performance and observability of the system; Power and performance optimization layers can significantly benefit from the information these embodiments provide. Furthermore, embodiments may be used as a filter (to keep or to avoid) for the type of information with respect to repeating behavior phases for debugging purposes, thus saving bandwidth in debugging subsystems. Furthermore, embodiments can be used as part of runtime malware detection that uses system statistics such as performance monitoring units. Automatic phase detection may be used as a guiding map for a power management system to decide how to manage the power consumption according to the discovered phases. Once a correct decision for a particular phase is realized, the previously obtained optimization decision may be reused and many of the optimization steps to recalculate the same result may be eliminated. This may improve the efficiency of a power management system.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A performance management system comprising:
a performance monitor to output performance monitoring signals;
a significant change identifier to receive input performance monitoring signals and output a prediction error function;
a filter to analyze the value indicating the level of change to identify a potential phase marker to indicate a beginning or end of a process phase;
an extractor to obtain phase properties for a phase delineated by at least a beginning phase marker; and
a predictor to determine an upcoming phase or estimate an ongoing phase from the obtained phase properties.

2. The system of claim 1, wherein the significant change identifier includes logic having a multivariate model predicting a signal from the input performance monitoring signals.

3. The system of claim 1, wherein the filter includes logic to analyze the prediction error function on the basis of outlier errors.

4. The system of claim 1, wherein the extractor includes logic to calculate a vector of properties of the phase.

5. The system of claim 1, wherein a complete phase is to be delineated by a beginning marker and an end marker.

6. The system of claim 1, further comprising logic to perform clustering to group recurring phases.

7. An apparatus to characterize workload phases comprising:
a significant change identifier to output a prediction error function from input system characteristics;
a filter to analyze the prediction error function to identify a potential phase marker to indicate at least a beginning or end of a process phase;
an extractor to obtain phase properties for a phase delineated by a beginning phase marker; and
a predictor to determine an upcoming phase or estimate an ongoing phase from the obtained phase properties.

8. The apparatus of claim 7, wherein the significant change identifier includes logic having a multivariate model predicting a signal from input system characteristics.

9. The apparatus of claim 7, wherein the filter includes logic to analyze prediction error function on the basis of outlier errors.

10. The apparatus of claim 7, wherein the extractor includes logic to calculate a vector of properties of the phase.

11. The apparatus of claim 7, wherein a complete phase is to be delineated by a beginning marker and an end marker.

12. The apparatus of claim 7, further comprising logic to perform clustering to group recurring phases.

13. A method to characterize workload phases of a process comprising:
inputting one or more signals indicating system characteristics to a significant change identifier to output a prediction error function;
filtering the prediction error function to identify a potential phase marker to indicate at least a beginning or an end of a process phase;
extracting phase properties for a phase delineated by at least a beginning phase marker; and
predicting an upcoming phase or estimating an ongoing phase from the extracted phase properties.

14. The method of claim 13, further comprising clustering to group recurring phases.

15. The method of claim 13, further comprising generating a phase vector from the extracted phase properties.

16. The method of claim 15, wherein predicting a future phase further comprises generating a history of phase property vectors and predicting a future phase based on a current phase and the generated history.

17. The method of claim 13, wherein the filtering identifies a potential phase marker based on the prediction error function being an outlier error.

18. The method of claim 13, wherein the significant change identifier includes logic having a multivariate model predicting a signal from input system characteristics.

19. At least one computer readable storage medium comprising a set of instructions which, when executed by a computing device, cause the computing device to:
input one or more signals indicating system characteristics to a significant change identifier to output a prediction error function;
filter the prediction error function to identify a potential phase marker to indicate a beginning or an end of a process phase;
extract phase properties for a phase delineated by at least a beginning phase marker; and
predict an upcoming phase or estimate an ongoing phase from the extracted phase properties.

20. The at least one computer readable storage medium of claim 19, wherein the instructions, when executed, cause the computing device to perform clustering to group recurring phases.

21. The at least one computer readable storage medium of claim 19, wherein the instructions, when executed, cause the computing device to generate a phase vector from the extracted phase properties.

22. The at least one computer readable storage medium of claim 21, wherein predicting a future phase further comprises instructions, when executed, that generate a history of phase property vectors and predict a future phase based on a current phase and the generated history.

23. The at least one computer readable storage medium of claim 19, wherein the instructions to filter the prediction error function further comprises identifying a potential phase marker based on the prediction error function being an outlier error.

24. The at least one computer readable storage medium of claim 19, wherein the significant change identifier includes logic having a multivariate model predicting a signal from input system characteristics.
